(19) United States
(12) Patent Application Publication
(10) Pub. No.: US 2007/0239331 A1
(43) Pub. Date: Oct. 11, 2007

(54) GPS, cellular, FM speed and safety control devise

(76) Inventor: Craig Robert Kaplan, Katonah, NY (US)

Correspondence Address: Craig Kaplan, 31 New Haven RR Street, Mount Vernon, NY, 10550, US

(21) Appl. No.: 11/645,551

(22) Filed: Dec. 26, 2006

Related U.S. Application Data
(60) Provisional application No. 60/753,612, filed on Dec. 24, 2005.

(51) Int. Cl. G06F 19/00

(52) U.S. Cl. 701/36

(57) ABSTRACT

A system, method and device for automatically controlling the maximum speed of a vehicle based upon the actual speed limit of a roadway being traveled by the vehicle by using a (GPS) receiver, the nationwide cellular network and FM signal to locate the position of vehicle in ‘real time’, using a computer control unit to control vehicle maximum speed by incorporating road speed limiting devises and governor, to identify vehicle operators using keyboard and scanner devises and to receive and send user specific information, navigational and remote operation of vehicle components.

### RELATED APPLICATION

This application claims the benefit of provisional application 60/753,612 filed Dec. 24, 2005

System, method and device's for automatically controlling the maximum speed of a vehicle based upon the actual speed limit of a roadway being traveled by the vehicle by using a Global Positioning Satellite (GPS) receiver, the nationwide cellemetry cellular network and FM signal to pinpoint the position of vehicle in ‘real time’, sending this information to a computer control unit (CCU) that is permanently installed and which has been previously set with the speed limits of all roadways (if the speed limit information is not presently available within the GPS system) and by incorporating the obtained information and using an electronic road speed control (ERSL) system or a road speed limiter (RSL) and engine governor depending on the age make and model of the vehicle to control the maximum speed of the vehicle as previously determined by imputed roadway speed limits and by also using the CCU to limit the use of the vehicle as determined by an ‘administrator’ of the vehicle (not unlike internet ‘parental controls’ for computer access) to allow access to vehicle when: (A) during permitted times of use (for new driver and the driving restrictions that go along with being a new driver by law), (B) during times deemed appropriate by the administrator and (C) not to allow unauthorized use by individuals not approved by the administrator by means of a ignition and starter ‘lockout’ devise by using a means of identification of an numerical code, password, retina and or fingerprint identification scanner all incorporated by the CCU that will allow for multiple user/s (as needed). In addition to positive identification a seatbelt use confirmation must also be acknowledged by the CCU to start vehicle via the same ignition/starter lockout device as well as the use of a Breathalyzer instrument. All of the above settings can be user specific as inputted by the administrator. The above ‘speed control and authorized access use system’ will not allow for a loss of control of acceleration (up to the speed limit of the roadway), deceleration or braking, it will only ‘limit’ the maximum speed of the vehicle, access and time use of vehicle as determined by the administrator of vehicle all of the settings can be disabled only by the administrator or service provider or pre programmed in this manor so that there are no restrictions on the administrator or others as the administrator deems appropriate. Vehicle will also be equipped with a GPS, cellular and FM transmitters to allow for tracking by administrator via a ‘home receiver/transmitter’ for personal tracking as well as by a ‘service provider’ of users and should the vehicle be stolen which can be hooked up to a home computer via a USB connector. CCU will always send out a signal that can be received by the ‘home receiver/transmitter’, the ‘service provider’ and by law enforcement authorities to locate vehicle if stolen, the ‘home receiver/transmitter will be able to track the vehicles speed, direction and location in real time and be able to send and receive messages to and from the CCU to the on-board monitor. The driver of the vehicle will also be able to receive directions, navigational information, view maps and receive and send messages from and to the ‘home-base receiver/transmitter or the service provider to the on-board monitor in conjunction with the GPS system and access to the WWW via the receivers/transmitters that are installed as well as send and receive ‘hands-free’ cellular transmission. The administrator by means of the ‘home receiver/transmitter’ or the ‘service provider’ will also be able to remotely lock/unlock power door locks, activate/disable ignition/starter lockout devise, sound horn to assist in locating lost vehicles in parking lots and receive reports on vehicle location, speed and direction. Examples of ERSL and RSL devises which may be used in connection with this invention include, but are not limited to, the 89 Series Road Speed Limiter and Engine Governor and the Electronic Road Speed Control with Combined Engine RPM Control, both manufactured by Sturdy Corporation (Wilmington, N.C.).

### BACKGROUND OF THE INVENTION

1. Field of the Invention

The invention relates generally to a safety system which incorporates GPS, Cellular and FM technologies to allow a computer system to regulate the maximum speed a vehicle can travel based upon specific roadway speed limits using road speed limiters of various types. The invention also allows for approved user capabilities as determined by an administrator of the vehicle along with navigational, remote operation of vehicle components (such as horn, door locks, etc.) and communication capabilities with a home-base operator or service provider.

2. Description of Related Art

It is often desirable to maintain the maximum speed of a given vehicle based upon specific roadway speed limits for safety reasons of individuals or companies. These reasons could be but are not limited to new drivers, freight companies, bus companies and the insurance industry.

Typical speed limiting devises only allow for a maximum speed limit allowed to be traveled. For example, if set for a maximum speed of 55 mph the vehicle could conceivably still travel 55 mph in a 30 mph speed zone.

By utilizing GPS, Cellular and FM transmitting and receiving devises exact location of the vehicle can be maintained as well as communication to/from the vehicle can be achieved. Using the three technologies above will allow for no ‘voids’ in tracking of the vehicle by a home base administrator and or service provider and allow for the retrieval of navigational information, road conditions and to send and receive communications to and from the vehicle.

It is also often desirable to be able to limit the use of a vehicle to specific users, specific times of use and for safety reasons of individuals or companies confirm use of seatbelts and confirm no alcohol use. Concerned parties could be but are not limited to parents, freight companies, bus companies, legal authorities and the insurance industry.

It is often desirable to be able to retrieve stored information regarding the use of a vehicle by a specific user which would include starting points and destinations, travel speed, time and duration of use. Concerned parties could be but are not limited to parents, freight companies, bus companies, legal authorities and the insurance industry.

It is often desirable to be able to locate a vehicle in a large parking facility when unsure of the vehicles location, unlock the doors if the keys are locked inside the vehicle or lost and to be able to do these activities remotely as needed.

While there are some products available that provides individual or some combined aspects of this invention there is no stand alone product that provides all of the capabilities of this invention in one single product.

### SUMMARY OF THE INVENTION

Briefly, and in general terms, the present invention relates to an integrated GPS-computer controlled speed, safety, user specific, remote operation of vehicle components and communication system and devise.

In a first aspect, the invention relates to a computer control system which allows for user specific access ability along with safety criteria that must be meet prior to vehicle use.

In a second aspect, the invention relates to a computer control system which, connected to GPS, cellular and FM receiver/transmitters and speed limiting devises allows for maximum speed control of specific roadways when traveled upon.

In a third aspect, the invention allows for communication to/from the vehicle a home-base or service provider to allow for messaging, navigational and operation of certain vehicle components.

In a forth aspect, the invention allows for the recording on vehicle information such as but not limited to; destination, travel speed and usage amount.

### BRIEF DESCRIPTION OF THE DRAWINGS

FIG. 1 is a block diagram depicting the aspects of the present invention showing the monitor, CCU, car battery and back up battery as well as switching which if power is cut from the car battery and internal back-up battery in the CCU provides power to the CCU to send out location information and reason/s for power failure.

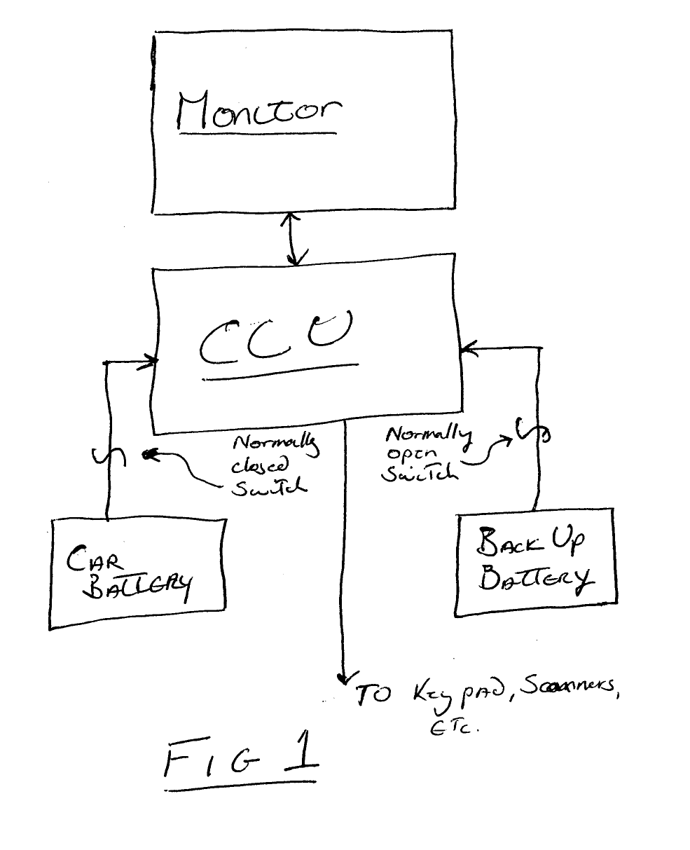

FIG. 2 is a block diagram depicting the CCU connected to the keypad, ID scanning and breathalyzer device that when satisfied along with the satisfaction of the seatbelt verification allows the CCU to close the normally open switch that disengages the starter and ignition lockout device. The GPS, Cellular and FM transmitter/receiver is then engaged to locate the vehicle so that the CCU can establish the roadway speed to limit the vehicle speed via the ERSL, RSL and or engine governor.

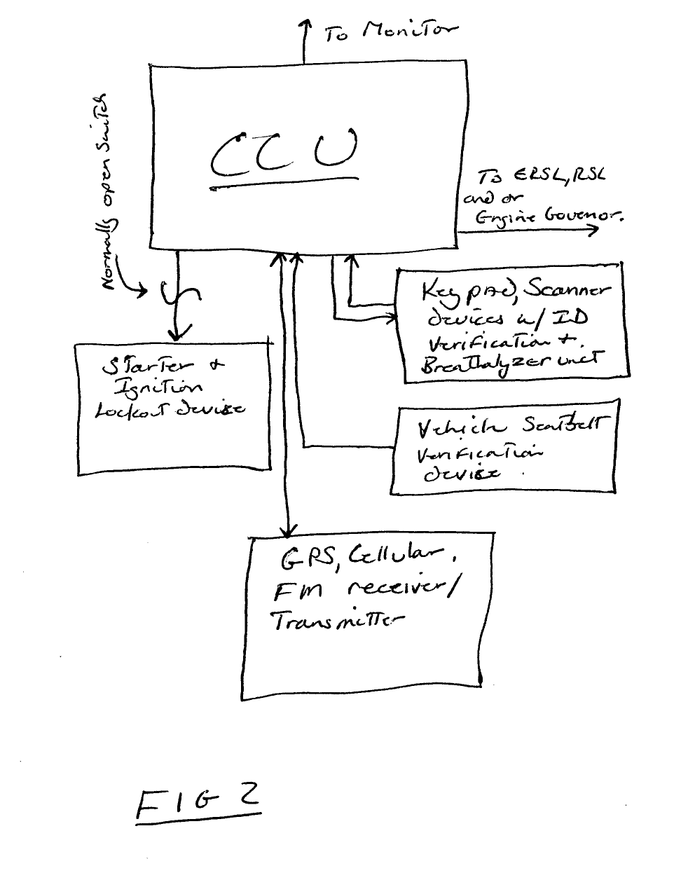

FIG. 3 is a block diagram depicting the CCU connected to the GPS, Cellular and FM transmitter/receiver, the RSL and or engine governor, the hands free cellular device and via GPS, Cellular and FM signal to the home-base and or monitoring service.

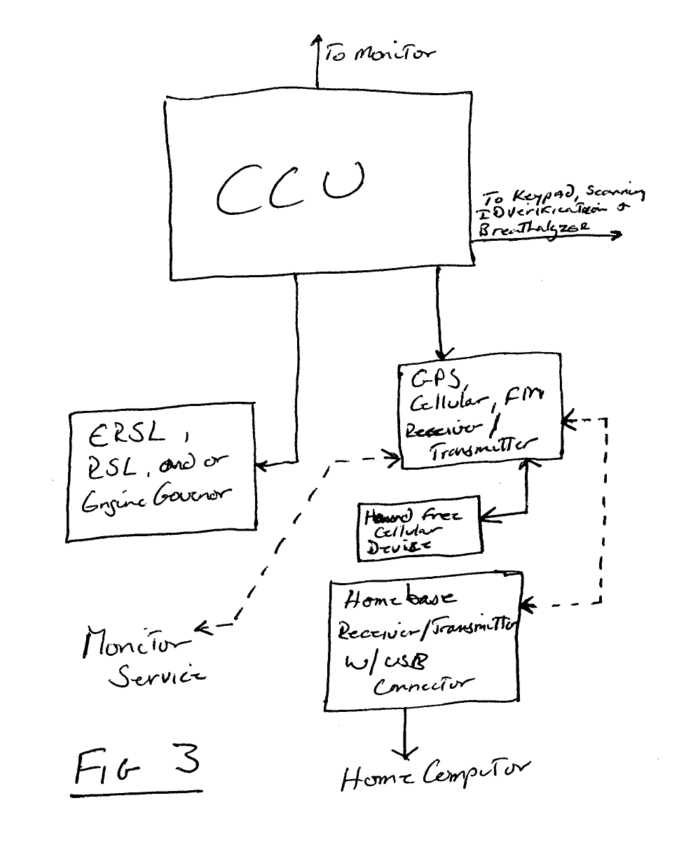

FIG. 4 is a block diagram depicting the aspects of the present invention

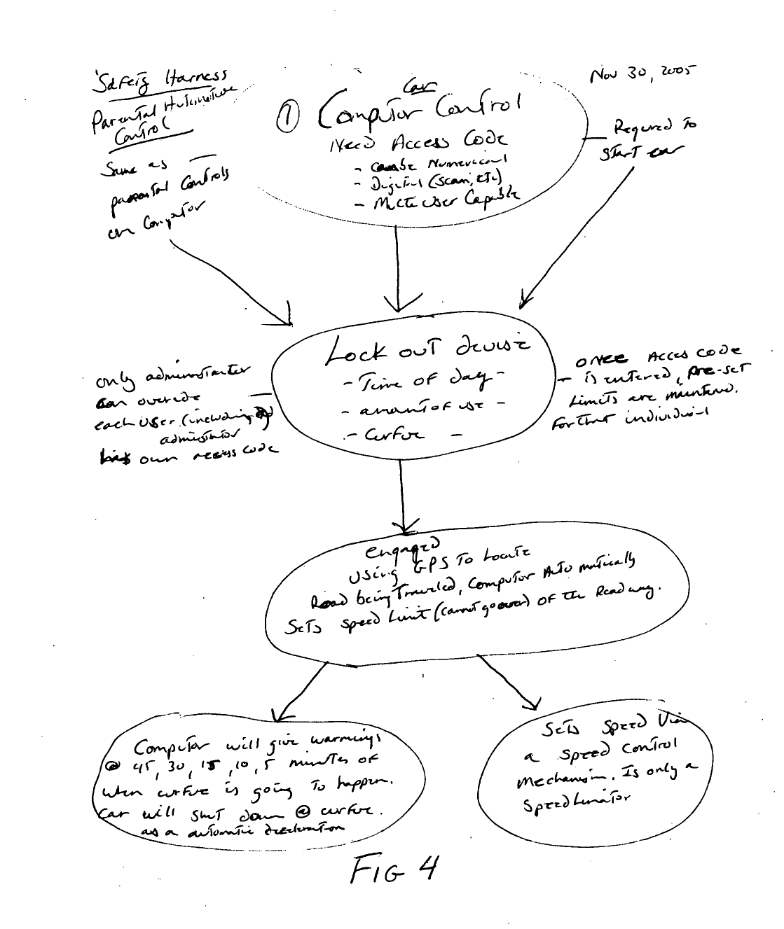

What is claimed is:

1. An speed and access limiting safety system which incorporates remote access by ‘home-base’ receiver/transmitter or service provider, an GPS system which is able to receive navigational information and current vehicle monitoring information as well as transmit the same information, a computer control unit (CCU) unit which connects all of the installed components including cellular and FM transmitters/receivers comprising: (1) CCU that first limits access to a vehicle by means of identifying individual users through numerical, password, fingerprint or retina scan as determined by an administrator for the vehicle by means of incorporating ignition and starter lockout devises; which will limit time of use and amount of use, not allow the vehicle to be started should the seatbelt/s not be engaged or if an alcohol breathalyzer is not satisfied all as previously determined by the vehicles ‘administrator’; (2) GPS, cellular and FM receivers and transmitters will be utilized, for receiving and transmitting GPS, cellular and FM signals; that will pinpoint vehicle in ‘real time’ on the specific roadway being traveled, data produced by processor in the CCU will determine location, speed and direction of vehicle on roadway by using GPS, cellular and FM signals and determine in ‘real time’ data the speed limit of the roadway; (3) and by use of either an electronic road speed control (ERSC) or a road speed limiter (RSL) and engine governor limit the maximum speed of vehicle to the maximum speed limit of the roadway; (4) transmitters will be used to remotely locate vehicle at any time with the ‘home receiver/transmitter’ or ‘service provider’ to assist with the opening of power locks, sound of horn to locate vehicle in a parking lot, to send text messages to vehicle monitor and if stolen, CCU will automatically send out transmission signal that can be received by the ‘home-base’ administrator, law enforcement authorities or ‘service provider’ to locate vehicle during regular use of vehicle can use the same transmission signals via a home base receiver/transmitter or ‘service provider’ the CCU and transmitter shall be equipped with a battery backup should power be cut to the CCU & transmitter system so that vehicle can be tracked if stolen or if an accident should occur with loss of power to vehicle, a ‘hands-free’ cellular phone devise is also incorporated into the system to allow for ‘hands-free’ cellular conversations, no loss of control in acceleration, deceleration or braking will occur, only maximum speed limiting and user access will take place, the CCU unit will have multi-purpose-built in GPS, cellular and FM comports to allow for easy hook-up and monitoring of multiple devises previously installed in vehicle and will record all information regarding usage, destinations, speed and all general information regarding a specific vehicle user during use which is accessible by the administrator.

2. The computer control unit (CCU) as set forth in claim 1, wherein the CCU is permanently installed and has multi-purpose built-in comports.

3. The CCU as set forth in claim 1, will firstly limit access to vehicle by means of identification being numerical, password, fingerprint or retina scan identification and if not satisfied will incorporate the ignition/starter lockout devises.

4. The CCU as set forth in claim 1, will secondly determine use of seatbelt/s by using sensors in seat (to determine if a person is in the seat) and sensor in seatbelt locking buckle (as already factory installed in vehicle) and use the same ignition/starter lockout devises.

5. The CCU as set forth in claim 1 will thirdly determine satisfaction of the alcohol breathalyzer unit and use same ignition/starter lockout devises.

6. The CCU as set forth in claim 1, will allow vehicle to be operated once identification, seatbelt and breathalyzer are properly satisfied and allow for driver specific settings previously imputed by the vehicle ‘administrator’ for allowed time and allowed duration of use of vehicle for said driver and allow for vehicle use.

7. The CCU as set forth in claim 1, will receive and record information from the GPS receiver and the vehicle in ‘real time’ to determine the location, direction and speed of vehicle on the specific roadway as well user specific information.

8. The CCU as set forth in claim 1 will process the location of vehicle in ‘real time’ and determine the speed limit of the roadway by means of received data or previously imputed speed limits of all roadways.

9. The CCU as set forth in claim 1 will by means of an ERSl or RSL and engine governor will limit the maximum speed that the vehicle will travel as determined by the location of vehicle as indicated by the GPS receiver/transmitter and the previously imputed speed limit of roadway being traveled.

10. The CCU as set forth in claim 1 will not allow for loss of control in acceleration, deceleration and braking, it will only allow for the limiting of the maximum speed of and for access to vehicle and for recording information regarding speed, direction, duration, destination of vehicle by any authorized (or unauthorized user if vehicle is stolen) user of vehicle.

11. The CCU as set forth in claim 1 wherein the CCU has a battery backup should power be cut to system and will automatically send out a transmission signal via the GPS, cellular or fm transmitters to the ‘home-base’ administrator or ‘service provider’ as to present location and previously recorded data as a default setting should power be cut.

12. The CCU as set forth in claim 1 shall be able to send and receive navigational and recorded information regarding vehicle location, speed, destination and directions.

13. The GPS, cellular and FM transmitters as set forth in claim 1 wherein the GPS, cellular and FM transmitters will automatically send out transmission signal should power be cut, by using the battery backup system or as requested by driver, administrator, ‘service provider’ or authorities.

14. The ERSL, RSL and or engine governor systems as set forth in claim 1 wherein the ERSL, RSl and or engine governor devices shall be controlled and the maximum speed set for a specific roadway being traveled by CCU processor by using the GPS, cellular and FM receiver/transmitters locator and roadway speed limit information stored and or obtained by CCU.

15. The ‘home receiver/transmitter’as set forth in claim 1 will have serial ports to allow for easy hook-up to a home computer and through the use of provided software be able via the GPS, cellular and FM receiver/transmitters or ‘service provider’ (if used) to access vehicle power locks, horn and lockout devices and send/receive messages to/from vehicle.

16. The devices are as follows; The CCU unit as set forth in claim 1 (with connectors for easy connection to vehicle computer and factory installed passive devices).

17. Ignition/starter lockout devices as set forth in claim 1 are connected to the CCU, personal identification devices, seatbelt indicators and breathalyzer equipment.

18. GPS/cellular/fm transmitter/receiver devises are permanently installed and connected to CCU as set forth in claim 1.

19. ERSC/RSL and engine governor devises are permanently installed and connected to CCU as set forth in claim 1.

20. An on-board monitor (to view directions, maps, navigational information and messages) devise is connected to CCU, GPS, Cellular and FM transmitters/receiver devises as set forth in claim 1.

21. Battery backup devises are permanently installed and are connected to CCU, GPS, FM and Cellular transmitter/receiver devises as set forth in claim 1.

22. Keyboard and scanning devises (for ID verification) are installed and connected to CCU and ignition/starter lockout devise as set forth in claim 3.

23. Seatbelt indicator devises are connected to CCU and ignition/starter lockout devises as indicated in claim 4.

24. Breathalyzer devise, to ensure no alcohol consumption is installed and connected to CCU and ignition/starter lockout devise as set forth in claim 5.

25. Home base receiver/transmitter with USB connector devise, ‘hands-free’ cellular component are connected to CCU via vehicles GPS, FM and Cellular receiver/transmitter devises installed in vehicle as set forth in claim 1.

26. ‘Service provider’ (if used) are connected to CCU via vehicles GPS, FM and Cellular receiver/transmitter devises installed in vehicle as set forth in claim 1.

27. The method for operation is as follows; when key is put into ignition the on-board monitor will activate and request user ID, driver will have to key-in password, have finger print or retina scan for ID verification to allow for deactivation of ignition/starter lockout devises which are connected to CCU as set forth in claim 3.

28. Seat-belt(s) devise must be satisfied as set forth in claim 4 to allow for deactivation of ignition/starter lockout devises for vehicle to start.

29. Breathalyzer must be satisfied as set forth in claim 5 to allow for deactivation of ignition/starter lockout devises for vehicle to start.

30. The on-board CCU will receive data from GPS/Cellular/FM receivers as set forth in claim 7 to identify location in real time and calculate the maximum speed limit of the roadway, the received information will be sent to the ERSL/RSL and or engine governor to limit the maximum speed.

31. Vehicle information, i.e. direction, destination, amount of use, etc., by individual users will be stored on the CCU for view and use by the ‘administrator’ as set forth in claim 1.
